(19) United States
(12) Patent Application Publication
(10) Pub. No.: US 2026/0129268 A1
(43) Pub. Date: May 7, 2026

(54) IDENTIFYING COMMERCIAL START AND END TIMES USING AD POD PROFILES

(71) Applicant: The Nielsen Company (US), LLC, New York, NY (US)

(72) Inventors: John T. LiVoti, Clearwater, FL (US); Stanley Wellington Woodruff, Palm Harbor, FL (US)

(21) Appl. No.: 19/371,782

(22) Filed: Oct. 28, 2025

Related U.S. Application Data
(60) Provisional application No. 63/714,964, filed on Nov. 1, 2024.

(51) Int. Cl. H04N 21/81; H04N 21/234; H04N 21/262

(52) U.S. Cl. CPC H04N 21/812; H04N 21/23418; H04N 21/26233

(57) ABSTRACT

In one example, a method is described. The method includes obtaining an advertisement pod. The advertisement pod is a consecutive set of advertisements shown in media content. The method includes identifying transitions in the advertisement pod; and applying, using a model, an advertisement pod profile of a plurality of advertisement pod profiles to the advertisement pod. The plurality of advertisement pod profiles are templates representing advertisement pods, and the advertisement pod profile includes known transitions corresponding to start times and end times of advertisements. The method includes determining that the known transitions of the advertisement pod profile overlap with at least a portion of the transitions of the advertisement pod such that the advertisement pod profile corresponds to the advertisement pod; and outputting data associated with the known transitions of the advertisement pod profile overlapping at least a portion of the transitions of the advertisement pod.

### CROSS-REFERENCE TO RELATED APPLICATIONS

This disclosure claims the benefit of U.S. Provisional Patent App. No. 63/714,964, filed Nov. 1, 2024, which is hereby incorporated by reference herein in its entirety.

### FIELD OF THE INVENTION

The present disclosure relates in general to advertisement (“ad”) detection, and in particular, to determining start and end times of advertisements using ad pod profiles.

### Usage and Terminology

In this disclosure, unless otherwise specified and/or unless the particular context clearly dictates otherwise, the terms “a” or “an” mean at least one, and the term “the” means the at least one.

### SUMMARY

In one aspect a method is described. The method includes obtaining an advertisement pod. The advertisement pod is a consecutive set of advertisements shown in a media content. The method also includes identifying transitions in the advertisement pod and applying, using a model, an advertisement pod profile of a plurality of advertisement pod profiles to the advertisement pod. The plurality of advertisement pod profiles are templates representing advertisement pods. The advertisement pod profile includes known transitions corresponding to respective durations of advertisements of the advertisement pod profile. The method also includes determining that the known transitions of the advertisement pod profile overlap with at least a portion of the transitions of the advertisement pod such that the advertisement pod profile corresponds to the advertisement pod and outputting data associated with the known transitions of the advertisement pod profile overlapping at least a portion of the transitions of the advertisement pod.

In another aspect, a non-transitory computer-readable storage medium, having stored thereon program instructions that, upon execution by a processor, cause performance of operations is described. The operations include obtaining an advertisement pod. The advertisement pod is a consecutive set of advertisements shown in a media content. The operations also include identifying transitions in the advertisement pod and applying, using a model, an advertisement pod profile of a plurality of advertisement pod profiles to the advertisement pod. The plurality of advertisement pod profiles are templates representing advertisement pods. The advertisement pod profile includes known transitions corresponding to respective durations of advertisements of the advertisement pod profile. The operations also include determining that the known transitions of the advertisement pod profile overlap with at least a portion of the transitions of the advertisement pod such that the advertisement pod profile corresponds to the advertisement pod and outputting data associated with the known transitions of the advertisement pod profile overlapping at least a portion of the transitions of the advertisement pod.

In another aspect, a computing system is described. The computing system includes a processor and a non-transitory computer-readable storage medium, having stored thereon program instructions that, upon execution by the processor, cause performance of operations. The operations include obtaining an advertisement pod. The advertisement pod is a consecutive set of advertisements shown in a media content. The operations also include identifying transitions in the advertisement pod and applying, using a model, an advertisement pod profile of a plurality of advertisement pod profiles to the advertisement pod. The plurality of advertisement pod profiles are templates representing advertisement pods. The advertisement pod profile includes known transitions corresponding to respective durations of advertisements of the advertisement pod profile. The operations also include determining that the known transitions of the advertisement pod profile overlap with at least a portion of the transitions of the advertisement pod such that the advertisement pod profile corresponds to the advertisement pod and outputting data associated with the known transitions of the advertisement pod profile overlapping at least a portion of the transitions of the advertisement pod.

### BRIEF DESCRIPTION OF THE DRAWINGS

FIG. 1 is a simplified block diagram of an example computing device in accordance with one or more aspects.

FIG. 2 is a diagrammatic illustration of a data flow of the example computing device in accordance with one or more aspects.

FIG. 3 is a simplified block diagram of a data flow of the computing device in accordance with one or more aspects.

FIG. 4A is a diagrammatic illustration of an ad pod in accordance with one or more aspects.

FIG. 4B is a diagrammatic illustration of a plurality of ad pod profiles in accordance with one or more aspects.

FIG. 4C is a diagrammatic illustration of the ad pod of FIG. 4A overlaid with each of the plurality of ad pod profiles of FIG. 4B in accordance with one or more aspects.

FIG. 5 is a flow chart of an example method in accordance with one or more aspects.

FIG. 6 is another flow chart of an example method in accordance with one or more aspects.

FIG. 7 is yet another flow chart of an example method in accordance with one or more aspects.

### DETAILED DESCRIPTION

### I. Overview

Media content can contain a program portion interleaved with advertisement portions (also referred to as “commercial breaks” and “advertisement (‘ad’) pods”). For example, television show A airs Friday at 7:30 pm Eastern time for thirty minutes and the total program content is 24 minutes in length and the total advertisement content portion is 6 minutes in length. The advertisement portion can be broken into a set of commercial breaks or ad pods that interrupt the program portion intermittently, and each such commercial break can have varying length and contain a varying number of individual advertisements. Moreover, the individual advertisements themselves can have varying length (such as advertisements of 30 seconds or 45 seconds or 60 seconds). Placement of advertisements to be interleaved within the program portion can be influenced by many factors (such as advertising inventory requirements, total program content length, scripting of the program content, and the like). Thus, both the timing of individual advertisements within media content, as well as, the total duration and makeup of such individual advertising breaks is not readily reducible to generally applicable rules. A model can be used to determine which portions of the media content correspond to the program portion and which correspond to the advertisement portions. Further, program guide information can be used to identify and/or validate start and end times of the media content. However, there is no advertisement guide information to identify and/or validate start and end times of advertisements within the advertisement portion of the media content.

In order to determine a commercial makeup of each commercial break (or “ad pod”), an ad pod profile can be applied to the ad pod to identify the start and end times of ads within each ad pod, as described herein. The ad pod profile is one of a plurality of stored ad pod profiles. The plurality of stored ad pod profiles represents all possible combinations of ads (including number of ads and duration of each ad) that could fit within the cumulative duration of the ad pod.

An ad pod profile of the plurality of stored ad pod profiles can be compared to the ad pod. The ad pod profile has a plurality of known transitions that would be compared to a plurality of detected transitions of the ad pod to determine if the ad pod profile is a match. For example, if the ad pod and the ad pod profile each have a total duration of one minute, and the ad pod profile has two thirty second commercials, then the ad pod profile would have three transitions. The detected transitions of the ad pod can be overlaid with the ad pod profile and if the transitions of the ad pod profile correspond to the transitions of the ad pod, then a match is determined.

Several examples are described herein for advantageously using ad pod profiles to determine start and stop times of ads within an ad pod. For example, detecting transitions within the ad pod can generate “false positives.” The transitions of the ad pod are detected, for example, by a change of a scene fading to black, which can indicate a switch from one advertisement to another or can be a feature of the advertisement itself. Therefore, using the ad pod profiles based on known ad lengths removes the “false positives”. Additionally, once an ad pod profile is selected as corresponding to the ad pod, the start and end times of the ads of the ad pod can be determined. Moreover, using the start and end times of the ads of the ad pod, the content of the ads can be determined using less computational processing power. For example, if the ads in the ad pod are identified as one-minute-long ads, then the ads can be queried against one-minute ads in a reference database rather than all ads in the reference database to identify the content of the ad.

Thus, the operations and systems, described herein, provide techniques for improving ad detection in particular by using ad pod profiles to determine start and end times of ads within an ad pod.

### II. System Architecture

Any one or more of the components described below can take the form of a computing device, or a computing system that includes one or more computing devices.

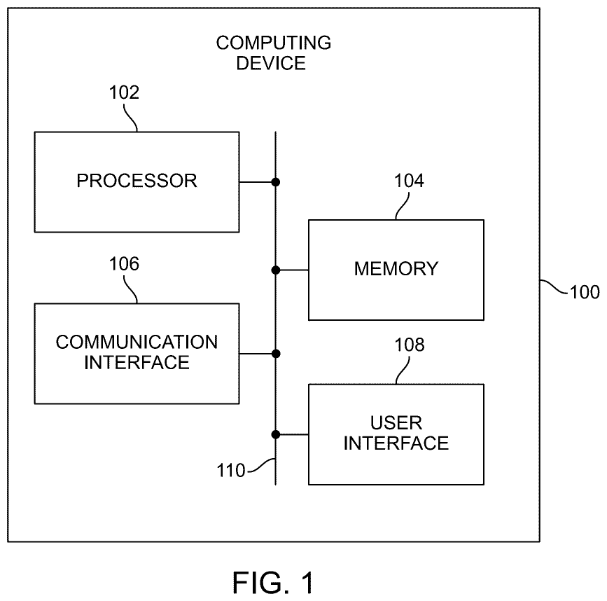

FIG. 1 is a simplified block diagram of an example computing device 100. The computing device 100 can be configured to perform one or more operations, such as the operations described in this disclosure. As shown, the computing device 100 can include various components, such as a processor 102, memory 104, a communication interface 106, and/or a user interface 108. These components can be connected to each other (or to another device, system, or other entity) via a connection mechanism 110.

The processor 102 can include one or more general-purpose processors and/or one or more special-purpose processors.

Memory 104 can include one or more volatile, non-volatile, removable, and/or non-removable storage components, such as magnetic, optical, or flash storage, and/or can be integrated in whole or in part with the processor 102. Further, memory 104 can take the form of a non-transitory computer-readable storage medium, having stored thereon computer-readable program instructions (e.g., compiled or non-compiled program logic and/or machine code) that, upon execution by the processor 102, cause the computing device 100 to perform one or more operations, such as those described in this disclosure. The program instructions can define and/or be part of a discrete software application. In some examples, the computing device 100 can execute the program instructions in response to receiving an input (e.g., via the communication interface 106 and/or the user interface 108). Memory 104 can also store other types of data, such as those types described in this disclosure. In some examples, memory 104 can be implemented using a single physical device, while in other examples, memory 104 can be implemented using two or more physical devices.

The communication interface 106 can include one or more wired interfaces (e.g., an Ethernet interface) or one or more wireless interfaces (e.g., a cellular interface, Wi-Fi interface, or Bluetooth® interface). Such interfaces allow the computing device 100 to connect with and/or communicate with another computing device over a computer network (e.g., a home Wi-Fi network, cloud network, or the Internet) and using one or more communication protocols. Any such connection can be a direct connection or an indirect connection, the latter being a connection that passes through and/or traverses one or more entities, such as a router, switcher, server, or other network device. Likewise, in this disclosure, a transmission of data from one computing device to another can be a direct transmission or an indirect transmission.

The user interface 108 can facilitate interaction between computing device 100 and a user of computing device 100, if applicable. As such, the user interface 108 can include input components such as a keyboard, a keypad, a mouse, a touch-sensitive panel, a microphone, and/or a camera, and/or output components such as a display device (which, for example, can be combined with a touch-sensitive panel), a sound speaker, and/or a haptic feedback system. More generally, the user interface 108 can include hardware and/or software components that facilitate interaction between the computing device 100 and the user of the computing device 100.

The connection mechanism 110 can be a cable, system bus, computer network connection, or other form of a wired or wireless connection between components of the computing device 100.

One or more of the components of the computing device 100 can be implemented using hardware (e.g., a digital signal processor (DSP), an application-specific integrated circuit (ASIC), a field-programmable gate array (FPGA), another programmable logic device, or discrete gate or transistor logic), software executed by one or more processors, firmware, or any combination thereof. Moreover, any two or more of the components of the computing device 100 can be combined into a single component, and the function described herein for a single component can be subdivided among multiple components.

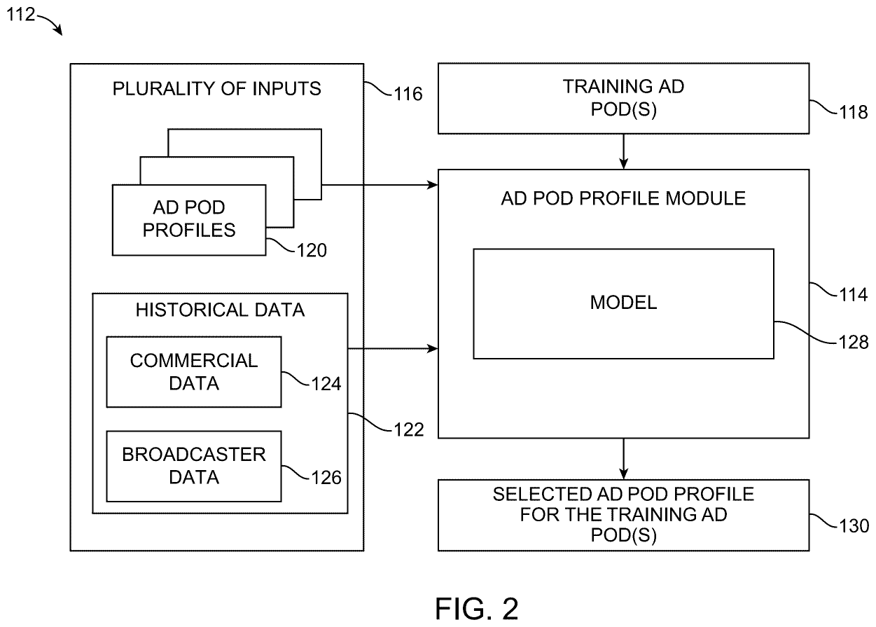

FIG. 2 is a diagrammatic illustration of a data flow of the computing device 100 generally referred to by reference number 112, in accordance with some aspects. Generally, the computing device 100 includes an advertisement (“ad”) pod profile module 114 that integrates data from a plurality of inputs 116 and training advertisement (“ad”) pod(s) 118. The plurality of inputs 116 include a plurality of advertisement (“ad”) pod profiles 120 and historical data 122 such as commercial data 124 and broadcaster data 126. The ad pod profile module 114 uses the plurality of inputs 116 and the training ad pod(s) to develop and train model 128 that selects an ad pod profile 130 for the training ad pod(s) 118 that matches (or alternatively, the ad pod profile 120 with the greatest score) the training ad pod(s) 118.

In some aspects, the plurality of inputs 116 can only include the ad pod profiles 120. The ad pod profiles 120 can include a plurality of ad pod profiles that correspond to various lengths of commercials or ads within an ad pod. The ad pod profiles 120 can include a plurality of templates that correspond to various ad pods, having a set of known transitions (e.g., a start of an advertisement at the 0 second mark is a first known transition for the template, an end of the advertisement at the 15 second mark is a second known transition for the template, and the like). For example, an ad can run six seconds, fifteen seconds, thirty seconds, or sixty seconds. One ad pod profile in the ad pod profiles 120 can correspond to four thirty second ads, while another ad pod profile in the ad pod profiles 120 consists of two sixty second ads. Additionally, or alternatively, the plurality of ad pod profiles can vary in total duration. For example, a first ad pod profile can have a total duration of two minutes, and a second ad pod profile can have a total duration of thirty seconds.

In one or more aspects, the training ad pod(s) 118 corresponds to the advertisement or commercial break and includes all the consecutive ads run over a period of time. The training ad pod(s) 118 can be a plurality of training ad pods run individually to train the model 128. The training ad pod(s) 118 can vary in length of time. For example, the training ad pod 118 can run for two minutes in length. In various instances, one training ad pod can vary in length of time in comparison to another training ad pod. For example, the training ad pod(s) can be a minute long, two minutes long, two and a half minutes long, and the like. In these cases, there can be a first set of ad pod profiles that corresponds to a first length of an ad pod (such as a two-minute-long ad pod) and a second set of ad pod profiles that corresponds to a second length of the ad pod (such as a minute-long ad pod). The first set of ad pod profiles can be saved in a database, separate from the second set of ad pod profiles, both of which are accessible by the ad pod profile module 114.

The historical data 122, in one or more aspects, can be excluded in training the model 128. In other aspects, the historical data 122 includes at least one of commercial data 124 or broadcaster data 126. The commercial data 124 can include historical commercial ad pods to train the model 128, so that the selected ad pod profile 130 from the training ad pod(s) 118 output by the model 128 can be validated. The broadcaster data 126 can include historical broadcasting data such as ABC® has run two-minute-long ad pods for the last five years; when a football game is shown, ad pods tend to be longer in time, but start and stop times of individual ads tend to be shorter; HULU® runs a longer ad pod followed by a shorter ad pod for a streamed movie; and the like. The historical data 122 can be used by the model 128 to weight an individual ad pod profile over another ad pod profile of the ad pod profiles 120 in determining the selected ad pod profile 130 for the training ad pod(s) 118. The historical data 122 can include a variety of sources including streaming and live television. The historical data 122 can be stored in a database. The historical data 122 can be updated periodically in order to retrain and update the model 128.

In several aspects, the model 128 is a machine learning module. The model 128 can be a deep learning module that uses a neural network. In particular, the neural network can be a transformer based neural network. The transformer based neural network is configured to process data in parallel. In other aspects, the model 128 is a pattern matching model.

The selected ad pod profile 130 for the training ad pod(s) 118, in several instances, is generated by the ad pod profile module 114 through the model 128. The selected ad pod profile 130 for the training ad pod(s) 118 can represent a particular ad pod profile from the ad pod profiles 120 selected by the model 128 or can represent the particular ad pod profile of the ad pod profiles 120 as applied to a training ad pod of the training ad pod(s) 118.

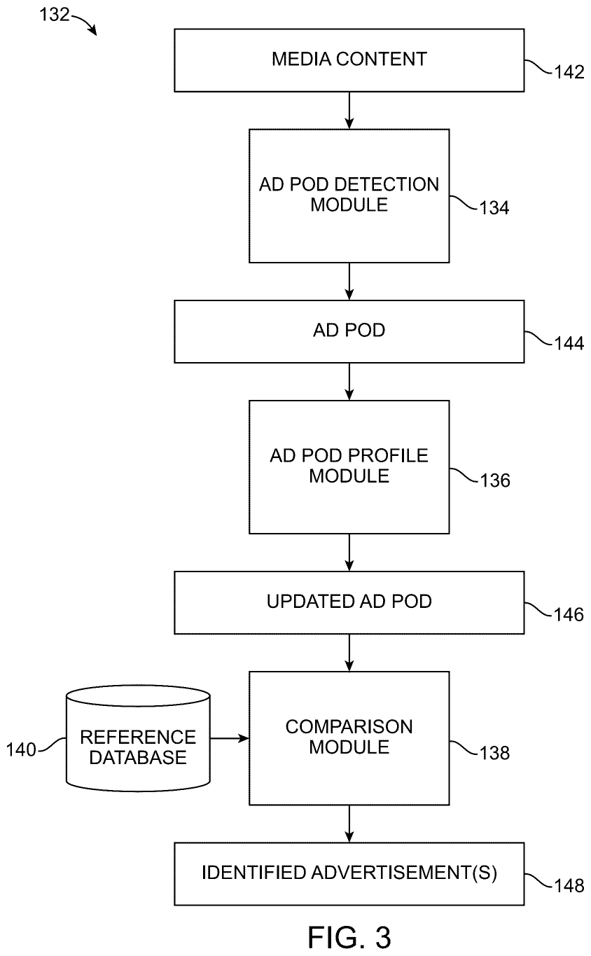

FIG. 3 is a simplified block diagram of a data flow of the computing device 100 generally referred to by reference number 132, in accordance with some aspects. As shown in FIG. 3, the computing device 100 includes the ad pod detection module 134, the ad pod profile module 136, the comparison module 138, and the reference database 140. The ad pod detection module 134 is in communication with the ad pod profile module 136. For example, the ad pod detection module 134 receives media content 142 as input and detects and isolates at least one ad pod from the media content 142 (such as ad pod 144) as an output. The ad pod 144 is an input for the ad pod profile module 136, which selects an ad pod profile that best matches the transitions (e.g., start and end times of an ad, durations of the ad, etc.) of the ads within the ad pod 144. The ad pod profile module 136 is in communication with the comparison module 138. The comparison module 138 compares a selected ad pod profile applied to the ad pod, which is an updated ad pod 146, with ads stored in the reference database 140. The reference database 140 is in communication with the comparison module 138. One or more identified advertisement(s) 148 are output from the comparison module 138 based on the comparison between the ads in the reference database 140 and the updated ad pod 146.

In several instances, the media content 142 is a program, television show, a movie, a video game, a music playlist, a podcast, video content, or other media content that contains one or more advertisements (or commercials) dispersed within and can be streamed and/or presented on a media presentation device such as a television, mobile phone, laptop, or the like. The media content 142 can be a video or an audio stream. The media content 142 can vary in length of time, such as, but not limited to thirty minutes, an hour, two hours, and three hours. The media content 142 includes both a program content portion (for example, an episode of television) and an advertisement content portion (e.g., commercial breaks). The program content portion and the advertisement content portion can be interleaved with each other such that the program content portion can be broken up by the advertisement content portion. The advertisement content portion can be one or more ad pods (e.g., periods of time of consecutive advertisements during a commercial break). The media content 142 can have a plurality of ad pods. The plurality of ad pods can be the same length throughout the media content 142 (such as two minutes), or the plurality of ad pods can vary within the media content 142 (such as a first ad pod being one minute and the second ad pod being two minutes). The media content 142 can be uploaded or transmitted to the computing device 100 and then sent to the ad pod detection module 134 for processing.

In one or more aspects, the ad pod detection module 134 is configured to receive the media content 142 and identify one or more ad pods such as the ad pod 144 within the media content 142. The ad pod detection module 134 is further configured to remove the program content portion of the media content 142, isolating the advertisement content portion (i.e., the one or more ad pods) for additional processing. The ad pod detection module 134 is further configured to send the ad pod 144 to the ad pod profile module 136. In some instances, a plurality of ad pods is sent to the ad pod profile module 136. The ad pod detection module 134 can include a transition detector to detect transitions within the ad pod 144, as described herein, such as segments of the video stream that have either fading to black or are black, audio silence, audio discontinuities, one or more black frames, or other aspects of the audio and/or video indicative of a scene change event that occur within a threshold duration of time, which can be as brief as one or a few frames of video at 24 frames per second (e.g., approximately 0.1 seconds).

The ad pod 144 corresponds to at least a portion of the advertisement content portion of the media content 142. For example, the ad pod 144 can run for one minute in length. The ad pod 144 can include a plurality of ads, and the plurality of ads can extend over the same amount of time within the ad pod 144. In other instances, at least one of the ads in the plurality of ads within the ad pod 144 differs in length of time. In various instances, the ad pod 144 can vary in length of time from other ad pods within the advertisement content portion. The ad pod 144 can be a minute long, two minutes long, two and a half minute long, fifteen seconds, six seconds, and the like.

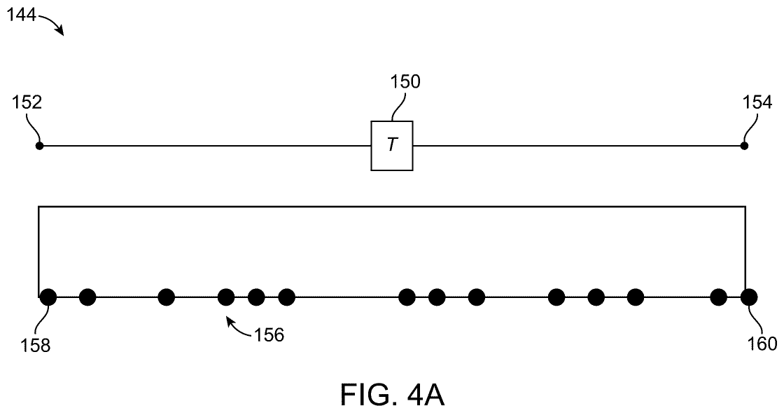

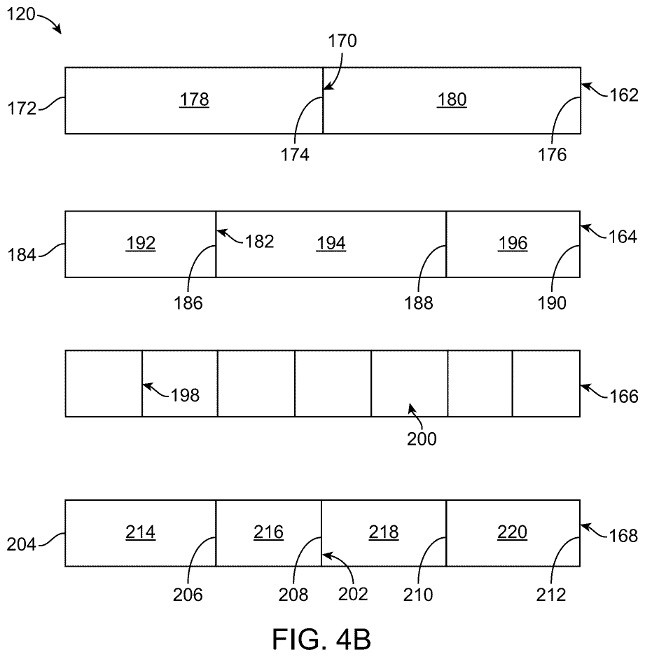

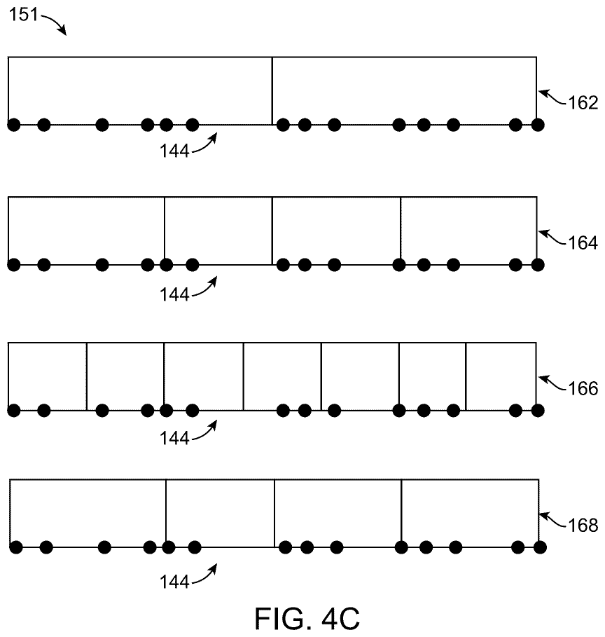

Referring to FIG. 4A, with continuing reference to FIGS. 1-3, the ad pod 144 is shown in more detail in accordance with one or more aspects. The ad pod 144 is video content that extends over a period of time (“T”) 150. T 150 extends from a start time 152 and an end time 154. T 150 corresponds to the total or cumulative duration of the ad pod 144. The ad pod 144 includes a plurality of transitions 156, where each transition of the plurality of transitions 156 are represented by circles on the ad pod 144. The plurality of transitions 156 represent changes from one content to another content, for example, when a first advertisement ends and a second advertisement begins, or when the program content of the media content 142 ends and a commercial break begins. Additionally, the plurality of transitions 156 can represent changes from one scene to another scene (such as when the video stream fades to black or is black). The plurality of transitions 156 includes at least a first transition 158 and a second transition 160. The first transition 158 corresponds to the start time 152. The second transition 160 corresponds to the end time 154. For example, when the media content 142 switches from the program content of the media content 142 to a commercial break, the first transition 158 is identified and corresponds to the start time 152 of the ad pod 144.

In some aspects, the plurality of transitions 156 can correspond to the time between the ending of a program to a start time of an ad, the time between one ad ending and the next ad starting, the time between the end of an ad and the start of the program, and/or another occurrence of the video content of the ad pod 144 turning black or fading to black, audio silence, audio discontinuities, one or more black frames, or other aspects of the audio and/or video indicative of a scene change event that occur within a threshold duration of time, which can be as brief as one or a few frames of video at 24 frames per second (e.g., approximately 0.1 seconds). Moreover, at least some detected transitions can correspond to scene changes that occur within a single advertisement, such as an advertisement that itself includes multiple distinct scenes. The plurality of transitions 156 can be a period of low light or shown via blackness on the screen. In some aspects, the ad pod detection module includes a transition detector that is a machine learning model that is trained to detect the plurality of transitions 156 of the ad pod 144. The transition detector can be the model 128. For instance, the transformer based neural network (the transition detector) is trained to look for transition streams (such as a screen fading to black, black screen, and/or no audio). The content before and after a transition of the plurality of transitions 156 of the ad pod 144 is noticeably different and can be identified by the transformer based neural network. The tolerance of the identified transition can be frame by frame in the video stream. For example, if using 30 frames per second, then the tolerance would be ± 1/30^{th} of a second. Alternatively, if using 60 frames per second, then the tolerance would be ± 1/60^{th} of a second. Further still, for North American broadcast content at 23.98 frames per second, the tolerance would accordingly be the inverse of the frame rate, ± 1/24^{th} of a second. And some examples can apply a multiple of the inverse frame rate, such as a tolerance that corresponds to 2 frames of the underlying video content, which would accordingly be represented by ± 2/30^{th} of a second, ± 2/60^{th} of a second, or ± 2/24^{th} of a second.

Referring again to FIG. 3, the ad pod profile module 136 is configured to receive the ad pod 144 as input and output the updated ad pod 146. In some instances, the ad pod profile module 136 is the ad pod profile module 114, after the ad pod profile module 114 has been trained. The ad pod profile module 136 can be coupled to one or more databases that store the ad pod profiles such as the ad pod profile 120 and/or other data such as historical data 122.

In various instances, the ad pod profile module 136 can include the transition detector to detect a portion of the plurality of transitions 156 of the ad pod 144. In particular, the ad pod profile module 136 can detect transitions occurring within the ad pod 144 indicating the various ads within the ad pod 144, whereas the ad pod detection module 134 can detect the first transition 158 and the second transition 160 indicating the start and ending of the ad pod 144.

Referring to FIG. 4B, with continuing reference to FIGS. 1-4A, exemplary ad pod profiles 120 are shown in accordance with one or more aspects. The ad pod profiles 120 can include a first ad pod profile 162, a second ad pod profile 164, a third ad pod profile 166, and a fourth ad pod profile 168. The ad pod profiles 120 can be stored in a database. The database can be in communication with the ad pod profile module 136.

The first ad pod profile 162 includes a plurality of transitions 170. For example, the first ad pod profile 162 includes the plurality of transitions 170 including a first transition 172, a second transition 174, and a third transition 176. For example, the first ad pod profile 162 can represent an ad pod that is two minutes in length and has a first advertisement profile 178 and a second advertisement profile 180. The first advertisement profile 178 is defined between the first transition 172 and the second transition 174. The second advertisement profile 180 is defined between the second transition 174 and the third transition 176. The first advertisement profile 178 and the second advertisement profile 180 can be each the same length within the first ad pod profile 162. For example, the first advertisement profile 178 and the second advertisement profile 180 can be each a minute in length. In some aspects, the first advertisement profile 178 is identical to the second advertisement profile 180.

The second ad pod profile 164 includes a plurality of transitions 182. For example, the second ad pod profile 164 includes a first transition 184, a second transition 186, a third transition 188, and a fourth transition 190. For example, the second ad pod profile 164 can represent an ad pod that is two minutes in length and has a first advertisement profile 192, a second advertisement profile 194, and a third advertisement profile 196. The first advertisement profile 192 is defined between the first transition 184 and the second transition 186. The second advertisement profile 194 is defined between the second transition 186 and the third transition 188. The third advertisement profile 196 is defined between the third transition 188 and the fourth transition 190. One or more of the first advertisement profile 192, the second advertisement profile 194, and the third advertisement profile 196 can be the same length within the second ad pod profile 164. For example, the first advertisement profile 192 and the third advertisement profile 196 can each be thirty seconds in length, while the second advertisement profile 194 can be a minute in length.

The third ad pod profile 166 includes a plurality of transitions 198. For example, the third ad pod profile 166 includes a plurality of advertisement profiles 200 where each advertisement profile is separated by a transition of the plurality of transitions 198. For example, the third ad pod profile 166 can represent an ad pod that is a minute and forty-five seconds in length. The plurality of advertisement profiles 200 can include seven advertisement profiles each at fifteen seconds in length. In other examples, the third ad pod profile 166 is the same total duration as the first ad pod profile 162, the second ad pod profile 164, and/or the third ad pod profile 166.

The fourth ad pod profile 168 includes a plurality of transitions 202. For example, the fourth ad pod profile 168 includes a first transition 204, a second transition 206, a third transition 208, a fourth transition 210, and a fifth transition 212. The fourth ad pod profile 168 can represent an ad pod that is two minutes in length and has a first advertisement profile 214, a second advertisement profile 216, a third advertisement profile 218, and a fourth advertisement profile 220. The first advertisement profile 214 is defined between the first transition 204 and the second transition 206. The second advertisement profile 216 is defined between the second transition 206 and the third transition 208. The third advertisement profile 218 is defined between the third transition 208 and the fourth transition 210. The fourth advertisement profile 220 is defined between the fourth transition 210 and the fifth transition 212. One or more of the first advertisement profile 214, the second advertisement profile 216, the third advertisement profile 218 can be the same length within the fourth ad pod profile 168. For example, the first advertisement profile 214 and the fourth advertisement profile 220 can be the same length, while the second advertisement profile 216 and the third advertisement profile 218 can be the same length, but a different length than the first advertisement profile 214 and the fourth advertisement profile 220.

In some aspects, the ad pod profiles 120 include a plurality of ad pod profiles at various total lengths. The total length of the ad pod profiles can, for example, be thirty seconds, a minute, two minutes, and the like. Some of the ad pod profiles can be longer than other ad pod profiles. The ad pod profiles 120 includes a plurality of advertisement profiles such as the first advertisement profile 178. The advertisement profiles can also vary in length (e.g., six seconds, fifteen seconds, thirty seconds, a minute, etc.). The number and type of advertisement profiles within an ad pod profile can vary. For example, the first ad pod profile 162 includes only two advertisement profiles, whereas the fourth ad pod profile 168 includes four advertisement profiles.

Referring to FIG. 4C, with continuing reference to FIGS. 1-4B, an overlay of the ad pod 144 with each of the first, second, third, and fourth ad pod profiles 162, 164, 166, and 168, respectively, is shown in accordance with one or more aspects and is generally referred to by reference numeral 151.

The ad pod profile module 136 can overlay or otherwise compare the plurality of transitions 156 (represented by circles) of the ad pod 144 to the plurality of transitions 170, 182, 198, and 202 (represented by vertical lines) of the first, second, third, and/or fourth ad pod profile 162, 164, 166, and 168, respectively in FIG. 4C. The ad pod profile module 136 then can determine which ad pod profile aligns with the plurality of transitions 156 of the ad pod 144. In the example of FIG. 4C, the second ad pod profile 164 will be selected as each transition of the plurality of transitions 182 are aligned with a transition of the plurality of transitions 156 of the ad pod 144. In this example, the updated ad pod 146 is the second ad pod profile 164 applied to the ad pod 144.

For the ad pod profile module 136 to determine the updated ad pod 146, at least a portion of the ad pod 144 is overlaid or compared to one or more of the ad pod profiles 120 such as the first, second, third, or fourth ad pod profiles 162, 164, 166, and/or 168, respectively. For example, in some aspects, if the ad pod 144 has transitions detected at 0 seconds, 5 seconds, 10 seconds, 30 seconds, 67 seconds, 72 seconds, 90.07 seconds, and 120 seconds, the ad pod 144 would be compared to the longest duration between two respective transitions in one or more ad pod profiles 120. For example, if the first ad pod profile 162 of the ad pod profiles 120 being compared to the ad pod 144 has transitions at 0 seconds, 60 seconds, and 120 seconds, then the longest duration between two respective transitions of the first ad pod profile 162 is the first 60 seconds (from 0 second to 60 seconds) or the second 60 seconds (from 60 seconds to 120 seconds). The longest duration that is first in time can be selected (e.g., from 0 seconds to 60 seconds). When the first 60 seconds of the first ad pod profile 162 is compared to the first sixty seconds of the ad pod 144, there is no match between transitions, as the ad pod 144 has transitions detected at 10 seconds, 30 seconds, and 67 seconds, which is outside the acceptable variance for threshold duration. Only a portion of the ad pod 144 is compared to the first ad pod profile 162 using the longest duration between two transitions of the first ad pod profile 162. By comparing only, a portion of the ad pod 144 to the first ad pod profile 162, less computational power is required. The first ad pod profile 162 can then be ruled out without further comparing the first ad pod profile 162 to the remainder of ad pod 144. All other ad pod profiles that have transitions at 60 seconds can also be ruled out. The model can ignore, discard, or disregard any ad pod profiles that have transitions at 60 seconds. The second ad pod profile 164 can then be selected. The second ad pod profile 164 can have transitions at 0 seconds, 30 seconds, 90 seconds, and 120 seconds. The longest duration of the second ad pod profile 164 is 60 seconds (from 30 seconds to 90 seconds). The ad pod 144 also has an approximate sixty second duration from 30 seconds to 90.07 seconds. A transition match can be determined by the model, since the transitions of the ad pod in comparison to the second ad pod profile 164 are within the acceptable variance for threshold duration. Since the longest transition period matched between the second ad pod profile 164 and the ad pod 144, the next longest transition period (from 0 seconds to 30 seconds and/or from 90 seconds to 120 seconds) of the second ad pod profile 164 is analyzed against the ad pod 144. The next longest transition period that is first in time can be selected. The ad pod 144 has a transition at 0 seconds and a transition at 30 seconds. The second ad pod profile 164 has transitions at 0 seconds and 30 seconds, since the transitions are identical, the ad pod 144 transitions are within the threshold variance. Next, the ad pod 144 has a transition at 90.07 seconds and a transition at 120 seconds. The transition at 120 seconds for the ad pod 144 matches with the transition at 120 seconds for the second ad pod profile 164, and the transition at 90.07 seconds for the ad pod 144 matches with the transition at 90 seconds for the second ad pod profile 164, as 0.07 seconds is within the acceptable variance for threshold duration. The transition points of 10 seconds, 67 seconds, and 72 seconds, and/or their corresponding duration periods, of the ad pod 144 do not match the second ad pod profile 164 and are ignored. In some instances, the transition points 10 seconds, 67 seconds, and 72 seconds are discarded. The transition points of 10 seconds, 67 seconds, and 72 seconds can be removed and/or not shown as part of the updated ad pod 146.

In particular, by eliminating alignment determinations with longer-duration advertising transitions that would subsequently be eliminated to the extent those same profiles failed to satisfy shorter-duration transitions within the same profiles, the search for a best-aligned one of a given set of ad pod profiles is made simultaneously faster and less burdensome or resource constraints related to memory usage and compute cycles, and thus more efficient.

In some instances, a total duration period is determined. In the example above, the total duration of the ad pod 144 is 120 seconds. Once a total duration period is calculated and/or determined, only ad pod profiles 120 with the same total duration are analyzed and/or compared to the ad pod 144. The total duration period can be determined before comparing the ad pod 144 to one of the ad pod profiles 120. The model can analyze from shortest duration between transitions within an ad pod to the longest duration between transitions within an ad pod (as described below).

In one or more aspects, once a match is determined by the ad pod profile module 136 based on a feature of the ad pod corresponding to a selected ad pod profile of the ad pod profiles 120 (e.g., transition point at 30 seconds, a 30 second duration between the first and second transition point in the ad pod 144 and the corresponding ad pod profile, and the like) all other ad pod profiles of the ad pod profiles 120 that have the same feature (e.g., transition point at 30 seconds, a 30 second duration between the first and second transition point in the ad pod 144 and the corresponding ad pod profile, and the like) are selected for comparison against the ad pod 144. Once a match is determined based on the feature of the ad pod corresponding to a selected ad pod profile, all remaining ad pod profiles of the ad pod profiles 120 that do not have that feature are ignored, discarded, or not compared with the ad pod 144.

In one or more aspects, the shortest duration between two transition points of the ad pod profile is used rather than the longest duration between two transition points of the selected ad pod profile. Prioritizing alignment based on the shortest duration transition portions of each ad pod profile enhances computational efficiency of the determination of which ad pod profile is best aligned with the ad pod 144 by only comparing a portion of the ad pod 144 with a portion of the selected ad pod profile.

In some examples, the threshold duration can vary by a few frames. For example, if the frames of the video are at 24 frames per second, then the allowed variance for the threshold duration can be, for example, approximately 0.1 seconds.

In several aspects, ad pod profiles 120 cumulative duration is compared to the cumulative duration of the ad pod 144 (e.g., the period of time T 150). For example, if the first ad pod profile 162 has a different cumulative duration than the cumulative duration of the ad pod 144, the first ad pod profile 162 is determined to not be a match to the ad pod 144. In one or more aspects, when the cumulative duration of one of the ad pod profiles 120 does not match the cumulative duration of the ad pod 144, then the respective ad pod profile of the ad pod profiles 120 is not compared or overlaid with the ad pod 144. Further, in some instances, only ones of the ad pod profiles 120 with cumulative durations that match that of the ad pod 144 (e.g., the period of time T 150) are selected for comparison by the ad pod profile module 136. In some instances, only one ad pod profile of the ad pod profiles 120 is applied or compared to the ad pod 144. In other instances, each ad pod profile of the ad pod profiles 120 is applied or compared to the ad pod profile. The ad pod profiles 120 can be overlaid onto the ad pod 144 to determine a score or match. The ad pod profile of the ad pod profiles 120 with the highest score or match can be selected as the updated ad pod 146.

Referring again to FIG. 3, the ad pod profile module 136 receives the ad pod 144 from the ad pod detection module 134 as an input. The ad pod profile module 136 is configured to apply one or more ad pod profiles to the ad pod 144 to determine which ad pod profile is the closest match, as described herein. The ad pod profiles can be obtained from a database that is in communication with the ad pod profile module 136. The ad pod profile module 136 can be configured to generate an updated ad pod 146 using the ad pod profiles.

In some instances, the updated ad pod 146 is a selected ad pod profile overlaid on the ad pod 144. The updated ad pod 146 can be selected, by the ad pod profile module 136, based on being one of a selected set of ad pod profiles having a set of transitions that best align with transitions 156 detected within the ad pod 144, as described herein. The comparison of which transitions best align with transitions 156 detected within the ad pod 144 can further be based on the timing tolerance of the transition timing. For instance, the ad pod profile module 136 can determine whether any of the set of ad pod profiles include transitions within the timing tolerance of the transitions 156 detected within the ad pod 144, and can disregard any transitions 156 of the ad pod 144 that fall outside of a tolerance of a given ad pod profile's transitions. Further still, the ad pod profile module 136 can weight the transitions 156 of the ad pod 144 according to their timing separation from the given ad pod profile's transitions in order to score the extent of alignment between the transitions 156 of the ad pod 144 and a given ad pod profile's transitions, with those transitions 156 outside the timing tolerance from a given ad pod profile's transitions relatively less weight than transitions within the timing tolerance. The selected set of ad pod profiles can be selected from amongst the ad pod profiles 120 based on having a total duration corresponding to the total period of time T 150 of the ad pod 144.

The updated ad pod 146 is an input for the comparison module 138. The comparison module 138 also receives inputs from the reference database 140. Using the updated ad pod 146 reduces the computational and storage requirements for the comparison module 138. The comparison module 138 can focus on comparing references in the references database that matches the transitions and/or advertisement profile of the updated ad pod 144, rather than comparing all references to the updated ad pod 146. For example, if the updated ad pod 146 has two one-minute commercials, then the comparison module 138 only searches for advertisements that are one-minute commercials, which reduces the computational requirements of the comparison. The comparison module 138 is configured to compare the updated ad pod 146 to a known set of advertisement references stored in the reference database 140 in order to output one or more identified advertisement(s) 148.

The reference database 140 can be stored within the computing device 100 or can be stored in a cloud or on another computing device that is accessible by the computing device 100. The reference database 140 stores a plurality of advertisement references for identification of advertisements within the ad pod 144. The reference database 140 can store signatures, watermarks, audio clips, visual clips, and the like associated with advertisements. The reference database 140 can be a plurality of databases. A first database of the plurality of databases can include advertisements that are a first length (e.g., fifteen seconds in length) and a second database of the plurality of databases can include advertisements that are a second length (e.g., thirty seconds). The comparison module 138 can access one or more of the plurality of databases based on the updated ad pod 146 and its respective ad lengths.

In some instances, the identified advertisement(s) 148 are sent for crediting or reporting that a user viewed the identified advertisement(s) 148 while watching the media content 142. The identified advertisement(s) 148 can include the type of commercial, the length of the commercial, the particular commercial, the brand or owner associated with the commercial, and the like. The identified advertisement(s)148 can be in a report generated and output by the comparison module 138. The report can also be sent for crediting.

FIG. 3 illustrates a particular exemplary aspect of data flow of the computing device 100. It is understood that this exemplary division and relationship between the modules can be modified without departing from the scope or spirit of the present invention. For example, the depicted modules such as the ad pod detection module 134 and the ad pod profile module 136 can be combined into larger modules. Additionally, functions can be distributed across several modules.

### III. Example Operations

The computing device 100 and/or components thereof can be configured to perform and/or can perform one or more operations. Examples of these operations and related features will now be described.

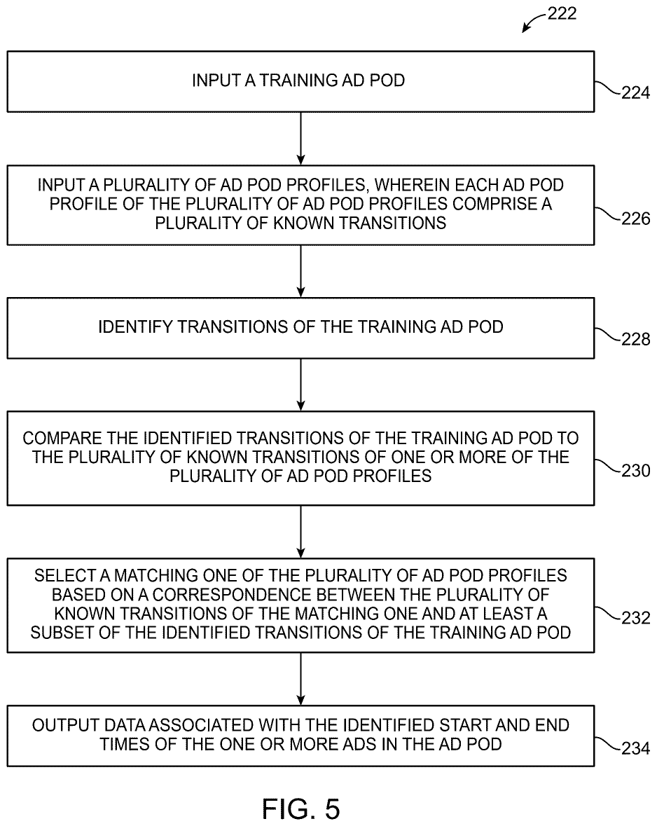

Referring to FIG. 5, with continuing reference to FIGS. 1-2, a method 222 for training a model, such as the model 128 of FIG. 2, is described. Method 222 is illustrated as a set of operations or blocks 224 through 234. Not all of the illustrated blocks 224 through 234 can be performed in all aspects of method 222. One or more blocks that are not expressly illustrated in FIG. 5 can be included before, after, in between, or as part of the blocks 224 through 234. In some aspects, one or more of the blocks 224 through 234 can be implemented, at least in part, by the computing device 100 and/or the ad pod profile module 114, in the form of executable code stored on non-transitory, tangible, machine-readable media that when run by one or more processors can cause the one or more processors to perform one or more of the processes. In one or more aspects, the blocks in method 222 are performed within a computing system, as described herein.

In an example aspect, the method 222 includes inputting a training ad pod at a block 224; inputting a plurality of ad pod profiles, where each ad pod profile of the plurality of ad pod profiles includes a plurality of known transitions, at a block 226; identifying transitions of the training ad pod at a block 228; Comparing the identified transitions of the training AD pod to the plurality of known transitions of one or more of the plurality of ad pod Profiles at a block 230; selecting a matching one of the plurality of ad pod profiles based on a correspondence between the plurality of known transitions of the matching one and at least a subset of the identified transitions of the training ad pod a block 232; and outputting data associated with the identified start and end times of the one or more ads in the ad pod at a block 234.

In some aspects, inputting the training ad pod at the block 224 includes inputting a plurality of training ad pods. The training ad pod at the block 224 can be the training ad pod(s) 118 of FIG. 2. The block 224 can include, in some instances, inputting the training ad pods into the ad pod profile module 114 to train the model 128.

In several aspects, the block 226 occurs before, after, or simultaneously to the block 224.

In some aspects, inputting the plurality of ad pod profiles at the block 226 includes populating and storing a plurality of ad pod profiles in one or more databases accessible to the ad pod profile module 114 and/or the computing device 100. The block 226 can be omitted or replaced with another block that retrieves one or more ad profiles of the plurality of ad profiles from the one or more databases. Each ad pod profile of the plurality of ad pod profile includes a plurality of known transitions. These known transitions can be stored in a variety of ways. For example, an example ad pod profile can represent an ad that has a first ad, having a length of thirty seconds, a second ad, having a length of thirty seconds, and then four consecutive ads, each having a length of fifteen seconds. The example ad pod profile can store time values associated with each transition, in one aspect. In another aspect, the example ad pod profile can include a visual representation of each ad within the ad pod, including points of transition. In some aspects, the ad pod profiles training the model 128 are the ad pod profiles 120.

In one or more aspects, an additional block is added after the block 226 to the method 222. The addition block trains the model such as the model 128 using historical data such as historical data 122. Historical data 122 such as commercial data 124 and/or broadcaster data 126 is fed into the model 128 to train the model. For example, if one broadcaster typically runs an ad pod having a two minute and fifteen second length then the model can be trained to weight ad pod profiles having two minute and fifteen second lengths greater than ad pod profiles having other lengths such as thirty second ad pod lengths, if the broadcaster is known. In some instances, the broadcaster and/or commercial is known using identification techniques such as watermark detection or signature identification. Additionally, or alternatively, commercial data can be used to train the model. For example, if a particular brand only airs thirty second ads and the brand has been identified in a commercial within the ad pod, then the model can weight ad pod profiles with thirty second transitions greater than ad pod profiles without thirty second transitions. In some aspects, the additional block occurs prior to and/or simultaneously to the block 226.

In several aspects, the block 228 includes identifying transitions of the training pod by using the ad pod profile module 114. In some aspects, the transitions of the training ad pod (such as the training ad pod(s) 118) can be identified by a user in order to train the model to identify the transitions. In other aspects, the model itself identifies transitions of the training pod by detecting instances when the screen fades to black, is black, lacks audio, contains no light, or the like, which indicates a beginning or an end of the training ad pod, which corresponds to a start and end of a commercial break within a program or a beginning or an end of one or more ads within the commercial break. In some instances, when the model is being trained to identify transitions of the training ad pod, a user manually validates the findings of the machine learning model to ensure accuracy and to further train the model.

In several aspects, at the block 228, a separate model is trained using the computing device 100 and/or the ad pod profile module 114 to identify transitions within ad pod and/or training ad pod such as the transition detector of the ad pod detection module 134. The training ad pod is input into the separate model and outputs identified transitions of the training ad pod. Then, the separate model feeds its output (e.g., the identified transitions) into a second model (such as model 128) to determine which ad pod profile corresponds to the training ad pod and/or the ad pod.

In some instances, at the block 230, comparing the identified transitions of the training ad pod to the plurality of known transitions of the one or more ad pod profiles includes overlaying or applying the training ad pod with one or more ad pod profiles of the plurality of ad pod profiles. In some aspects, only one ad pod profile of the ad pod profiles 120 is applied or overlaid to the training ad pod at the block 230. In other instances, a plurality of the ad pod profiles 120 is applied or overlaid to the training ad pod (such as at the training ad pod(s) 118) at the block 230. In some aspects, the block 230 compares the identified transitions of the training ad pod to the plurality of known transitions of one or more ad pod profiles using pattern matching.

One or more additional blocks can be used to weighting one or more ad pod profiles based on historical data such as the historical data 122 prior to block 232.

In one or more aspects, at the block 234, the ad pod profile with the greatest match is selected. A match can be determined if a threshold value is exceeded such as a 75% or an 85% match. In one or more instances, at least two ad pod profiles of the plurality of ad pod profiles are compared to the training ad pod and the ad pod profile with the best match to the training pod is selected at the block 232. The ad pod profile with the best match has the greatest number of transitions matched between the ad pod profile and the training ad pod, satisfies a set threshold value, and the like. In other instances, one or more ad pod profiles can be applied to the training ad pod until a match is determined, and once a match is selected at the block 232, then no other ad pod profiles are used to determine a match. In some instances, a match is determined only when there is a 100% match between all transitions in an ad pod profile and a number of transitions in the ad pod.

One or more additional blocks can be used to identify start and end times of the one or more ads in the ad pod after the block 232 once the matching one of the plurality of ad pod profiles had been selected.

In several aspects, the block 234 occurs after the model is trained. A new ad pod is input at the block 224 into the model and then at the block 234, data associated with start and end times of the one or more ads in the new ad pod is output. The data associated with the start and end times of the one or more ads in the ad pod can be the matching one of the plurality of ad pod profiles selected to be a match with the new ad pod, time values associated with the start and times of the one or more ads in the new ad pod, the duration of each ad in the new ad pod, the number of ads in the ad pod profile, a likelihood that the ad pod is from a particular broadcaster, and the like. For example, if the ad pod profile selected is 45 seconds in length and broadcaster Y is the only broadcaster known for running 45 seconds ad pods, the output data can include info relating to the broadcaster Y.

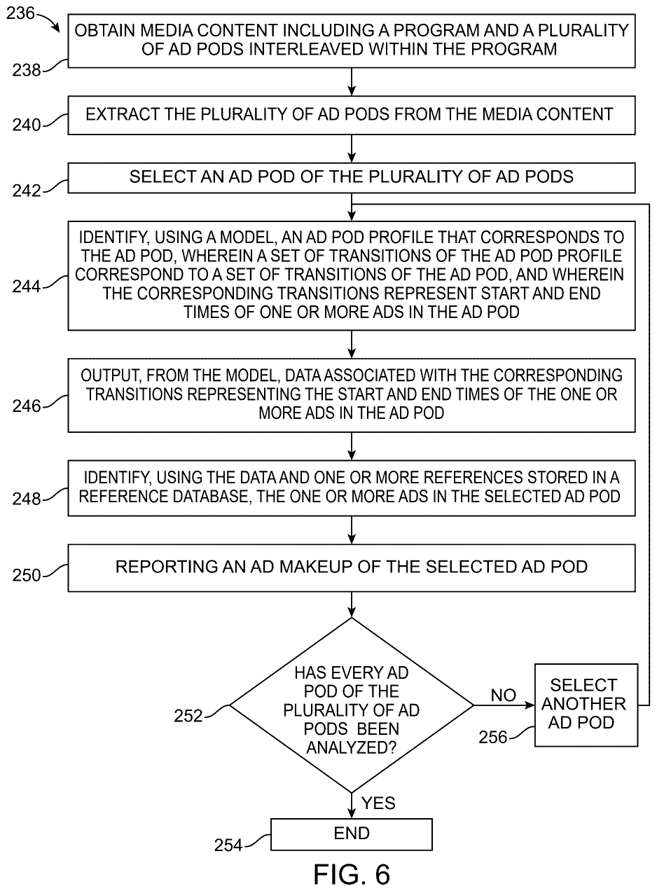

Referring to FIG. 6, with continuing reference to FIGS. 1-5, a method 236 for determining a makeup of one or more ad pods within media content is described. Method 236 is illustrated as a set of operations or blocks 238 through 256. Not all of the illustrated blocks 238 through 256 can be performed in all aspects of method 236. One or more blocks that are not expressly illustrated in FIG. 6 can be included before, after, in between, or as part of the blocks 238 through 256. In some aspects, one or more of the blocks 238 through 256 can be implemented, at least in part, by the computing device 100 such as one or more of the ad pod detection module 134, the ad pod profile module 136, the comparison module 138, and the reference database 140, in the form of executable code stored on non-transitory, tangible, machine-readable media that when run by one or more processors can cause the one or more processors to perform one or more of the processes. In one or more aspects, the blocks in method 236 are performed within a computing system, as described herein.

In an example aspect, the method 236 includes obtaining media content including a program and a plurality of ad pods interleaved within the program at a block 238; extracting the plurality of ad pods from the media content at the block 240; selecting an ad pod of the plurality of ad pods at the block 242; and identifying, using a model, an ad pod profile that corresponds to the selected ad pod, where a set of transitions of the ad pod profile correspond to a set of transitions of the ad pod, and where the corresponding transitions represent start and ed times of one or more ads in the ad pod at a block 244; outputting, from the model, data associated with the corresponding transitions representing the start and end times of the one or more ads in the ad pod at the block 246; identifying, using the data and one or more references stored in a reference database, the one or more ads in the selected ad pod at a block 248; reporting an ad makeup of the selected ad pod at a block 250; determining if every ad pod of the plurality of ad pods has been analyzed at a block 252; if so, then end the method 236 at a block 254; and if not, select another ad pod at a block 256 and proceed to the block 244.

In some aspects, at the block 238, media content such as media content 142, which includes both the program content portion (for example, a streamed movie) and an advertisement content portion is received by the computing device 100, a server, or the like.

In one or more aspects, at the block 240, the advertisement content portion is extracted from the program content portion of the media content 142. The program content portion can be discarded at the block 240 or analyzed by another computing device to identify the program content portion at the block 240. The advertisement content portion corresponds to the plurality of ad pods from the media content 142. The block 240 can use the ad pod detection module 134 to extract the plurality of ad pods from the media content.

In some examples, only a single ad pod is extracted from the media content. For example, if the media content had a single ad pod before the program content portion was shown. In some aspects, the ad pod 144 is extracted.

In various instances, the block 242 selects an ad pod to analyze from a plurality of ad pods extracted from the media content. This step can be omitted if there is only one ad pod in the media content. The ad pod can be selected based on chronological order.

An additional block can be added to the method 236. The additional block can be for identifying transitions of each ad pod of the plurality of ad pods. The additional block can use the ad pod detection module 134. The transitions of each ad pod of the plurality of ad pods can include identifying the transition from the program content portion to the advertisement content portion and the transition back to the program content portion, which corresponds to the start and end time of the entire ad pod. In some instances, the transitions within the ad pod are identified at a later time. In other instances, the ad pod detection module 134 detects all transitions within the ad pod including the start and end times of the entire ad pod, each ad within the ad pod. The ad pod detection module 134 can also detect additional transitions within the ad pod. For example, a single advertisement changes scenes (or fades to black) then continues with the same advertisement. The ad pod detection module 134 would identify three transitions rather than two, which is why the ad pod profile is used to determine which two of the three transitions are the start and end times of the advertisement. The additional block can identify the transitions using a machine learning model (such as the transition detector) that is trained to detect a change in scene such as when the scene fades to black. The ad pod 144 can include the transitions identified by the additional block. The additional block can also calculate the total duration, also referred to as, cumulative duration of the ad pod.

The block 244 can use the model described in FIG. 5 to identify an ad pod profile that corresponds to the selected ad pod from the block 242. In some aspects, the model can be implemented by the ad pod profile module 136. The block 244 can include applying one or more ad pod profiles stored in one or more databases accessible by the ad pod profile module 136. The one or more ad pod profiles are applied to the selected ad pod, such as the ad pod 144, as described herein, for FIG. 4C. The block 244 can overlay or compare at least a portion of the ad pod to one or more of the ad pod profiles using the model. For example, in some aspects, if the ad pod has transitions detected at 0 seconds, 10 seconds, 30 seconds, 43.3 seconds, 48.2 seconds, 60.1 seconds, 72 seconds, and 120 seconds, the ad pod is compared, using the model, to the shortest duration between two respective transitions in one or more ad pod profiles, at the block 244. For example, if the first selected ad pod profile of the ad pod profiles being compared to the ad pod has transitions at 0 seconds, 15 seconds, 30 seconds, 60 seconds, and 120 seconds. The shortest duration between two respective transitions of the ad pod profile is the first fifteen seconds (from 0 second to 15 seconds). When the first fifteen seconds of the ad pod is compared to the first fifteen seconds of the ad pod, there is no match between transitions, as the ad pod has a transition detected at 10 seconds and 30 seconds, which is outside the acceptable variance for threshold duration. Only a portion of the ad pod is compared to the first selected ad pod profile using the shortest duration of the ad pod profile. The first selected ad pod profile can then be ruled out without further comparing the first selected ad pod profile to the ad pod. All other ad pod profiles that have transitions at 0 seconds and 15 seconds can also be ruled out by the model. A second ad pod profile can then be selected from a database. The second selected ad pod profile can have transitions at 0 seconds, 30 seconds, 60 seconds, and 120 seconds. The shortest duration of the second selected ad pod profile is 30 seconds (from 0 seconds to 30 seconds and again from 30 seconds to 60 seconds). Since the second selected ad pod profile has two instances of the shortest duration, the first in time (from 0 seconds to 30 seconds) can be selected for comparison against the ad pod. The ad pod also has a thirty second duration from 0 seconds to 30 seconds. A transition match can be determined, and since the transitions were identical between the second ad pod profile and the ad pod at the 0 and 30 second transitions, the transitions are within the acceptable variance for threshold duration. Since the first transition period matched between the second selected ad pod and the ad pod, the next shortest transition period (from 30 seconds to 60 seconds) of the second selected ad pod is analyzed against the ad pod. The ad pod has a transition at 30 seconds, as previously described, and a transition at 60.1 seconds. The transition at 30 seconds for the ad pod matches with the transition at 30 seconds for the second selected ad pod, and the transition at 60.1 seconds for the ad pod matches with the transition at 60 seconds for the second selected ad pod as 0.1 seconds is within the acceptable variance for threshold duration. Once again the second selected ad pod matches with the ad pod, the next shortest duration time of the second selected ad pod would be selected (from 60 seconds to 120 seconds). The transition at 60.1 seconds for the ad pod matches with the 60 second transition for the second selected ad pod (as described above), and the transition at 120 seconds for the ad pod matches with the transition at 120 seconds for the second selected ad pod As the two transition are identical, the two transition at 120 seconds are within the acceptable variance for threshold duration. The transition points of 10 seconds, 30 seconds, 43.3 seconds, 48.2 seconds, 60.1 seconds, and 72 seconds, and/or their corresponding duration periods, of the ad pod do not match the second ad pod profile and are ignored. In some instances, the transition points 10 seconds, 30 seconds, 43.3 seconds, 48.2 seconds, 60.1 seconds, and 72 seconds are discarded at the block 244.

In some instances, the longest duration between transitions within an ad pod profile is selected rather than the shortest duration between transitions.

In some instances, a total duration of the ad pod is determined at the block 244 instead of the block 242. In the example above, the total duration of the ad pod is 120 seconds. Once a total duration period is calculated and/or determined, only ad pod profiles with the same total duration are analyzed and/or compared to the ad pod. The total duration period can be determined before comparing the ad pod to one of the ad pod profiles.

In one or more aspects, once a match is determined at the block 244 based on a feature of the ad pod corresponding to a selected ad pod profile of the ad pod profiles (e.g., transition point at 30 seconds, a 30 second duration between the first and second transition point in the ad pod and the corresponding ad pod profile, and the like) all other ad pod profiles of the ad pod profiles that have the same feature (e.g., transition point at 30 seconds, a 30 second duration between the first and second transition point in the ad pod and the corresponding ad pod profile, and the like) are selected for comparison against the ad pod. Once a match is determined based on the feature of the ad pod corresponding to a selected ad pod profile, all remaining ad pod profiles of the ad pod profiles that do not have that feature are ignored, discarded, or not compared with the ad pod at the block 244.

In one or more aspects, the shortest duration between two transition points of the ad pod is used at the block 244 to identify the ad pod profile that corresponds to the ad pod, rather than the shortest duration between two transition points of the selected ad pod profile. The threshold duration can vary by a few frames. For example, if the frames of the video are at 24 frames per second, then the allowed variance for the threshold duration can be, for example, approximately 0.1 seconds.

In some aspects, prioritizing alignment based on the shortest duration transition portions of each ad pod profile enhances computational efficiency of the determination of which ad pod profile is best aligned with the ad pod at the block 244. In particular, by eliminating alignment determinations with longer-duration advertising transitions that would subsequently be eliminated to the extent those same profiles failed to satisfy shorter-duration transitions within the same profiles, the search for a best-aligned one of a given set of ad pod profiles is made simultaneously faster and less burdensome or resource constraints related to memory usage and compute cycles, and thus more efficient.

In several aspects, the model can apply one or more ad pod profiles to the ad pod and generate a score or confidence level for each ad pod profile, where the score is described herein.

In other aspects, time values of transitions of the ad pod profiles are stored in one or more databases and time values of transitions of the selected ad pod are stored in another database, and the model determines a match based on comparing the time values of transitions of the ad pod profiles and the time values of transitions of the selected ad pod.

In one or more aspects, the model uses a transformer based neural network to determine transition and/or to determine if the transitions of the ad pod profile match the transitions of the ad pod. The model can use a tolerance based on frame by frame in the video stream. For example, if the video stream captures sixty frames per second, the tolerance would be ± 1/60^{th} of a second.

In various instances, the block 246 outputs data associated with the corresponding transitions, which represent the start and end times of the one or more ads in the selected ad pod. For example, the data output can be at least one of: the identified ad pod profile that corresponds to the selected ad pod, the updated ad pod 146, the number of ads of in the ad pod, the duration of each ad in the ad pod, the cumulative duration of the entire ad pod, the corresponding transitions between the identified ad pod profile and the ad pod; the transitions of the ad pod to discarded/ignored, and the like. The block 246 can output the data to a database for storage. The block 246 can output the data to the comparison module 138.

In some aspects, the block 248 is implemented using the comparison module 138 and/or the reference database 140. The block 248 can use the data output by the block 246. For example, the data from block 246 can identify that the ad pod had two advertisements each one minute in length, and therefore, the comparison module 138 can query the reference database for advertisements that are one minute in length thereby reducing the required computing processing power. Additionally, or alternatively, the data from the block 246 can include one or more advertisements within the ad pod itself, and the comparison module 138 can match signature(s) of the one or more advertisements to reference signatures stored in the reference database 140. Other techniques for identification of advertisements can be used such as watermark detection or techniques for identifying a brand or logo within the advertisement. In some aspects, the block 248 is omitted and the content of the ads of the ad pod are not identified, rather only the structure of the ad pod is identified and reported at the block 250.

In one or more instances, the ad makeup of the selected ad pod is reported at the block 250. The block 250 can also include crediting by an audience measurement entity that a viewer watched the one or more ads in the ad pod. The block 250 can generate a report that includes at least one of: the structure of the ad pod such as the duration of the ad pod and the duration of each ad in the ad pod, the order of the ads in the ad pod, the content of one or more ads in the ad pod, the identified advertisement(s) 148, broadcaster information associated with the ad pod, and the like. In some aspects, the block 250 occurs at the end of the method 236 and reports the ad makeup of all ad pods within the media content.

In some aspects, the block 254 occurs simultaneously to the block 242 or the block 244. In other aspects, the block 254 occurs after the block 246, the block 250, or the block 252. The block 254 can be omitted if the media content only had one ad pod. The block 254 determines if the ad pods have been analyzed to determine the start and end times of one or more ads in the ad pod, using an identified ad pod profile.

If every ad pod of the plurality of ad pods within the media content has been analyzed then the block proceeds to block 254 and the method 236 ends. Otherwise, another ad pod from the plurality of ad pods is selected and the method 236 proceeds to the block 244. In some instances, the ad pods are selected in chronological order within the media content.

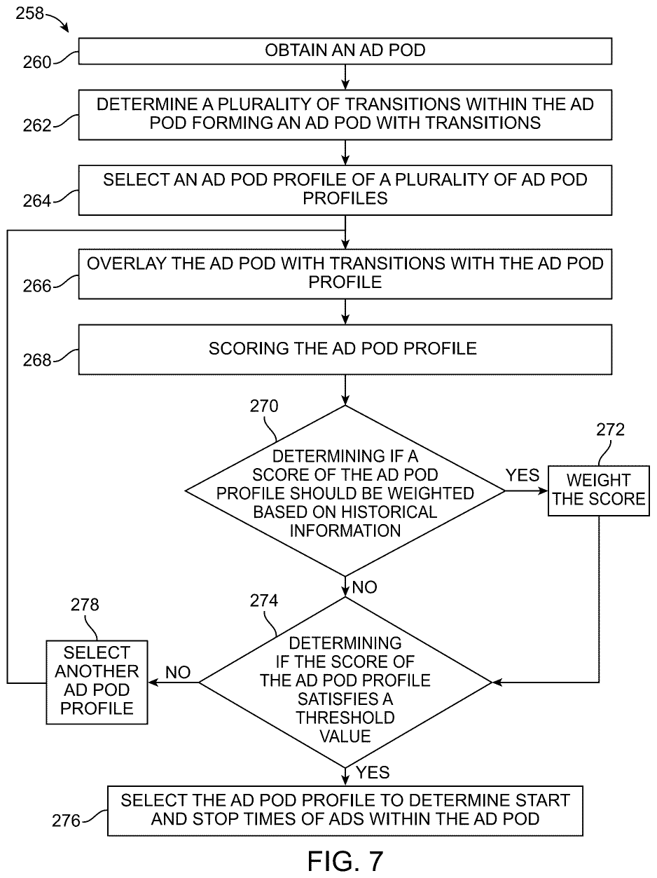

Referring to FIG. 7, with continuing reference to FIGS. 1-6, a method 258 for selecting an ad pod profile to determine start and stop times of ads within an ad pod is described. Method 258 is illustrated as a set of operations or blocks 260 through 278. Not all of the illustrated blocks 260 through 278 can be performed in all aspects of method 258. One or more blocks that are not expressly illustrated in FIG. 7 can be included before, after, in between, or as part of the blocks 260 through 278. In some aspects, one or more of the blocks 260 through 278 can be implemented, at least in part, by the computing device 100 such as the ad pod detection module 134 and the ad pod profile module 136, in the form of executable code stored on non-transitory, tangible, machine-readable media that when run by one or more processors can cause the one or more processors to perform one or more of the processes. In one or more aspects, the blocks in method 258 are performed within a computing system, as described herein.

In an example aspect, the method 258 includes obtaining an ad pod at a block 260; determining a plurality of transitions within the ad pod forming an ad pod with transitions at a block 262; selecting an ad pod profile of a plurality of ad pod profiles at a block 264; overlaying the ad pod with transitions with the ad pod profile at a block 266; scoring the ad pod profile at a block 268; determining if a score of the ad pod profile should be weighted based on historical information at a block 270; if yes, then weighting the score at a block 272 and then proceeding to a block 274; if no, then proceeding directly to the block 274 and determining if the score of the ad pod profile satisfies a threshold value; if yes, then selecting the ad pod profile to determine start and stop times of ads within the ad pod at a block 276; and if no, then selecting another ad pod profile at a block 278 and proceeding to the block 266.

In several aspects, an ad pod or a plurality of ad pods are received by the computing device 100 at the block 260. The ad pod can correspond to an advertisement content portion or a commercial break of a media content. The ad pod can be obtained by extracting the ad pod from the media content. The ad pod can be the ad pod 144. The ad pod 144 can be obtained from the ad pod detection module 134.

In some aspects, the ad pod detection module 134 determines the plurality of transitions within the ad pod from an ad pod with transitions. For example, with reference to FIG. 4A, the ad pod detection module 134 can only identify the first transition 158 and the second transition 160 in order to separate the ad pod 144 (or a plurality of ad pods) from the remainder of the media content 142. In other aspects, the plurality of transitions 156 are identified by the ad pod detection module 134. In some aspects, the ad pod 144 is the ad pod with transitions. The ad pod detection module 134, in some aspects, can use a machine learning model such as the transition detector to detect the plurality of transitions within the ad pod. The transition detector can map and/or determine the plurality of transitions in the ad pod. The transition detector can identify the plurality of transitions by determining the black screens during the ad pod. Other known methods for transitioning ads can be used at the block 262 by the transition detector and/or the ad pod detection module 134 to detect the plurality of transitions.

In several instances, the ad pod detection module 134 can detect the start and end time of the ad pod, but not the transitions within the ad pod. The ad pod detection module 134 can be configured to detect the program portion of the media content transitioning (e.g., the screen fading to black) to the ad portion of the media content (e.g., the ad pod) and when the advertisement portion of the media content transitions back to the program portion of the media content. In other instances, the ad pod detection module 134 can detect the start and end time of the ad pod and the transitions within the ad pod. The ad pod detection module 134 can be configured to detect periods of the ad pod where the video content is black or fading to black and mark those periods as transitions. The ad pod detection module 134 can use additional techniques to determine a transition point such as a lack of audio, comparing one screen to another screen to determine if a scene change has occurred, or the like.

In one or more aspects, an additional block is included after the block 262 that updates the ad pod with the plurality of transitions. For example, the plurality of transitions can be identified, marked, or otherwise noted on the ad pod to compare with the ad pod profiles.

In various aspects, an additional block is included after the block 262 that determines a cumulative duration of the ad pod with transitions by determining a time value from a first transition to the last transition of the plurality of transitions.

In some aspects, the block 264 includes accessing a database storing a plurality of ad pod profiles. In other aspects, the block 264 includes accessing a plurality of databases. For example, one database can include ad pod profiles that are for ad pods of two minutes in length; and a second database can include ad pod profiles that are for ad pods of thirty seconds in length. In some aspects, the block 264 includes selecting a first ad pod profile based on the first ad pod profile being the first ad pod profile being stored in the database. In other aspects, the first ad pod profile is the first ad pod profile in the database that matches the length of the ad pod.

In several instances, the block 266 overlays the ad pod with transitions with the ad pod profile selected in the block 264 or vice versa. The block 266 can be performed using the ad pod profile module 136. The ad pod with transitions can be the ad pod 144 and overlaid with the ad pod profile (such as the first ad pod profile 162) as shown in FIG. 4C and/or as described in FIG. 6. In some aspects, the ad pod profile serves as a transition template to match with the ad pod.

In one or more aspects, the ad pod profile is scored to determine if the ad pod profile corresponds to and/or matches the ad pod. The ad pod profile corresponds to and/or matches the ad pod when the transitions of the ad pod profile matches the transitions of the ad pod. For example, referring back to FIG. 4C, the first and last transitions of the first ad pod profile 162 matches the first and last transitions of the ad pod 144 showing that the ad pod profile and the ad pod are the same overall duration; however, the middle transition of the first ad pod profile 162 does not align with a transition of the ad pod 144, which shows that the length of the advertisements within the ad pod 144 differs from the first ad pod profile 162. The score can be a numerical value, confidence value, or percentage that shows the likelihood that the ad pod profile matches the ad pod, and specifically that the start and end times of each ad in the ad pod corresponds to transitions of the ad pod profile. The score can also consider if the difference between the transition of the ad pod and the corresponding transition of the ad pod profile is within a threshold duration (e.g., the transition of the ad pod is a few hundredths of a second different than the transition of the ad pod profile) in scoring the ad pod profile.

In some aspects, the block 270 is omitted. In other aspects, the block 268 includes the block 270 to determine if the score of the ad pod profile should be updated based on historical information. If so, then the block proceeds to the block 272 to weigh the score. For example, if it is known that the ad pod is from Broadcaster Y and historical information (such as historical data 122) relating to Broadcaster Y states that Broadcaster Y generally does not run minute long ads, then if the ad pod profile being scored is a minute and a half in duration the score will be weighted at the block 272. Therefore, historical information can be used to weight or increase a score of an ad pod. Once the score is weighted, then the method 258 proceeds from block 272 to block 274. However, if the ad pod profile is a minute long ad from Broadcaster Y, then the method 258 proceeds to the block 274 without being weighted.

In various instances, the block 274 determines whether the score of the ad pod profile satisfies a threshold value. The threshold value can correspond to a greater than 60%, 75%, 80%, 85%, or 90% chance that the transitions of the ad pod profile correspond to the transitions of the ad pod. For example, returning to FIG. 4C, when the ad pod 144 is overlaid with the second ad pod profile 164, the transitions of the second ad pod profile 164 each correspond to a transition of the ad pod 144, this would be a 100% match, and therefore, the threshold value is satisfied. In some instances, threshold value corresponding to a 95% or 100% chance of a match is used at the block 274.

In other instances, at the block 274, a plurality of ad pod profiles is scored and the highest score is selected, rather than comparing each score to the threshold value. For example, if an ad pod profile has transitions detected at 0 seconds, 14.99 seconds, 30 seconds, 45 seconds, and 60.01 seconds and is compared to an ad pod profile having transitions at 0 seconds, 30 seconds, 60 seconds, then all three transitions of the ad pod profile would overlap with the ad pod. If the ad pod profile is compared to another ad pod profile having transitions at 0 seconds, 15 seconds, 30 seconds, 45 seconds, and 60 seconds, then all five transitions of the other ad pod profile overlaps with the transitions of the ad pod. The block 274 can determine or score the another ad pod profile higher than the ad pod profile because the number of transitions that overlap between the another ad pod profile and the ad pod is greater than the number of transitions that overlap between the ad pod profile and the ad pod. Additionally, or alternatively, at the block 274, a plurality of ad pod profiles can have an identical score. Historical reference data, which can include historical reference data about a network or a specific program, can be used to weight one ad pod profile over another ad pod profile. For example, if the program is a television show known to historically run an ad pod made up of a 3 second ad, followed by a 15 second ad, followed by a 6 second ad, the ad pod profile that corresponds to the historical information is weighted more heavily, than ad pod profiles that veer from the historical reference data.

In one or more aspects, the threshold value is not satisfied at the block 274, and the method 258 proceeds from the block 274 to the block 278. The block 278 can select the next ad pod profile and then proceed to the block 266. The ad pod profile can be obtained from the one or more databases. In some aspects, this block is omitted. For example, a plurality of ad pod profiles can be simultaneously analyzed in relation to the ad pod to determine which ad pod profile of the plurality of ad pod profiles produces the best match between the transitions of the ad pod profiles and the transitions of the ad pod. In this example, rather than using a threshold value, each ad pod profile is compared to the other ad pod profiles of the plurality of ad pod profiles being simultaneously analyzed to determine which ad pod profile is the best fit or match to the ad pod. Instead of a numerical value, the score is a Boolean comparison of when the transitions of the ad pod profile overlays with the transitions of the ad pod (e.g., yes, the transitions are the same or no, the transitions is different), and the ad pod profile having most or all of its transitions overlaid with transitions of the ad pod is selected as the ad pod profile of the block 276.

In some aspects, the block 276 includes selecting the ad pod profile to determine the start and stop times of the ad pod profile and the method 258 ends. The ad pod profile selected can be the ad pod profile with the highest score, the ad pod profile that satisfies the threshold value, and/or the ad pod profile that has the most overlap between the number of transitions of the ad pod and the ad pod profile. The ad pod profile can be applied to the ad pod at the block 276 to determine start and stop times of the ads within the ad pod. In other aspects the block 276 includes outputting data associated with the selected ad pod profile such as described in the block 246 of the method 236.

In some aspects, only ad pod profiles of the same cumulative duration as the ad pod are selected at the block 278. For example, if the ad pod has a cumulative duration of thirty seconds, then all ad pod profiles that have a differing cumulative duration are not analyzed.

### IV. Example Variations

Although the examples and features described above have been described in connection with specific entities and specific operations, in some scenarios, there can be many instances of these entities and many instances of these operations being performed, perhaps contemporaneously or simultaneously, on a large-scale basis.

In addition, although some of the operations described in this disclosure have been described as being performed by a particular entity, the operations can be performed by any entity, such as the other entities described in this disclosure. Further, although the operations have been recited in a particular order and/or in connection with example temporal language, the operations need not be performed in the order recited and need not be performed in accordance with any particular temporal restrictions. However, in some instances, it can be desired to perform one or more of the operations in the order recited, in another order, and/or in a manner where at least some of the operations are performed contemporaneously/simultaneously. Likewise, in some instances, it can be desired to perform one or more of the operations in accordance with one more or the recited temporal restrictions or with other timing restrictions. Further, each of the described operations can be performed responsive to performance of one or more of the other described operations. Also, not all of the operations need to be performed to achieve one or more of the benefits provided by the disclosure, and therefore not all of the operations are required.

Although certain variations have been described in connection with one or more examples of this disclosure, these variations can also be applied to some or all of the other examples of this disclosure as well and therefore aspects of this disclosure can be combined and/or arranged in many ways. The examples described in this disclosure were selected at least in part because they help explain the practical application of the various described features.

Also, although select examples of this disclosure have been described, alterations and permutations of these examples will be apparent to those of ordinary skill in the art. Other changes, substitutions, and/or alterations are also possible without departing from the invention in its broader aspects as set forth in the following claims.

What is claimed is:

1. A method comprising:
obtaining an advertisement pod, wherein the advertisement pod is a consecutive set of advertisements shown in a media content;
identifying transitions in the advertisement pod;
applying, using a model, an advertisement pod profile of a plurality of advertisement pod profiles to the advertisement pod,
wherein the plurality of advertisement pod profiles are templates representing timing of transitions between consecutive advertisements within advertisement pods, and
wherein the advertisement pod profile comprises known transitions corresponding to respective durations of advertisements of the advertisement pod profile;
determining that the known transitions of the advertisement pod profile overlap with at least a portion of the transitions of the advertisement pod such that the advertisement pod profile corresponds to the advertisement pod; and
outputting data associated with the known transitions of the advertisement pod profile overlapping at least a portion of the transitions of the advertisement pod.

2. The method of claim 1, further comprising:
determining a duration of the advertisement pod;
selecting a set of advertisement pod profiles from the plurality of advertisement pod profiles based on the duration of the advertisement pod corresponding to durations of the set of advertisement pod profiles,
wherein the selected set of advertisement pod profiles includes the advertisement pod profile;
and
comparing the transitions of the advertisement pod with transitions of each of the selected set of advertisement pod profiles, wherein the determining that the known transitions of the advertisement pod profile overlap is based on the comparing.

3. The method of claim 1, wherein the advertisement pod is a portion of a video stream; and wherein identifying the transitions in the advertisement pod comprises identifying segments in the portion of the video stream that are either fading to black or black.

4. The method of claim 3, wherein identifying the transitions in the advertisement pod further comprises using the model to identify the segments.

5. The method of claim 3, further comprising:
indicating, after identifying, the transitions on the advertisement pod.

6. The method of claim 1, wherein applying, using the model, the advertisement pod profile of the plurality of advertisement pod profiles to the advertisement pod comprises overlaying the advertisement pod profile with the advertisement pod.

7. The method of claim 6, wherein overlaying the advertisement pod profile with the advertisement pod comprises overlaying the known transitions of the advertisement pod profile with at least a portion of transitions of the advertisement pod.

8. A non-transitory computer-readable storage medium, having stored thereon program instructions that, upon execution by a processor, cause performance of a set of operations comprising:
obtaining an advertisement pod, wherein the advertisement pod is a consecutive set of advertisements shown in a media content;
identifying transitions in the advertisement pod;
applying, using a model, an advertisement pod profile of a plurality of advertisement pod profiles to the advertisement pod,
wherein the plurality of advertisement pod profiles are templates representing advertisement pods, and
wherein the advertisement pod profile comprises known transitions corresponding to start times and end times of advertisements;
determining that the known transitions of the advertisement pod profile overlap with at least a portion of the transitions of the advertisement pod such that the advertisement pod profile corresponds to the advertisement pod; and
outputting data associated with the known transitions of the advertisement pod profile overlapping at least a portion of the transitions of the advertisement pod.

9. The non-transitory computer-readable storage medium of claim 8, the set of operations further comprising:
determining a duration of the advertisement pod;
selecting a set of advertisement pod profiles from the plurality of advertisement pod profiles based on the duration of the advertisement pod corresponding to durations of the set of advertisement pod profiles,
wherein the selected set of advertisement pod profiles includes the advertisement pod profile;
and
comparing the transitions of the advertisement pod with transitions of each of the selected set of advertisement pod profiles, wherein the determining that the known transitions of the advertisement pod profile overlap is based on the comparing.

10. The non-transitory computer-readable storage medium of claim 8, wherein the advertisement pod is a portion of a video stream; and wherein identifying the transitions in the advertisement pod comprises identifying segments in the portion of the video stream that are either fading to black or black.

11. The non-transitory computer-readable storage medium of claim 10, wherein identifying the transitions in the advertisement pod further comprises using the model to identify the segments.

12. The non-transitory computer-readable storage medium of claim 8, wherein applying, using the model, the advertisement pod profile of the plurality of advertisement pod profiles to the advertisement pod comprises overlaying the advertisement pod profile with the advertisement pod.

13. The non-transitory computer-readable storage medium of claim 12, wherein overlaying the advertisement pod profile with the advertisement pod comprises overlaying the known transitions of the advertisement pod profile with at least a portion of transitions of the advertisement pod.

14. A computing system comprising:
a processor; and
a non-transitory computer-readable storage medium, having stored thereon program instructions that, upon execution by the processor, cause performance of a set of operations comprising:
obtaining an advertisement pod, wherein the advertisement pod is a consecutive set of advertisements shown in a media content;
identifying transitions in the advertisement pod;
applying, using a model, an advertisement pod profile of a plurality of advertisement pod profiles to the advertisement pod,
wherein the plurality of advertisement pod profiles are templates representing advertisement pods, and
wherein the advertisement pod profile comprises known transitions corresponding to start times and end times of advertisements;
determining that the known transitions of the advertisement pod profile overlap with at least a portion of the transitions of the advertisement pod such that the advertisement pod profile corresponds to the advertisement pod; and
outputting data associated with the known transitions of the advertisement pod profile overlapping at least a portion of the transitions of the advertisement pod.

15. The computing system of claim 14, the set of operations further comprising:
determining a duration of the advertisement pod;
selecting a set of advertisement pod profiles from the plurality of advertisement pod profiles based on the duration of the advertisement pod corresponding to durations of the set of advertisement pod profiles,
wherein the selected set of advertisement pod profiles includes the advertisement pod profile;
and
comparing the transitions of the advertisement pod with transitions of each of the selected set of advertisement pod profiles, wherein the determining that the known transitions of the advertisement pod profile overlap is based on the comparing.

16. The computing system of claim 14, wherein the advertisement pod is a portion of a video stream; and wherein identifying the transitions in the advertisement pod comprises identifying segments in the portion of the video stream that are either fading to black or black.

17. The computing system of claim 16, wherein identifying the transitions in the advertisement pod further comprises using the model to identify the segments.

18. The computing system of claim 16, further comprising:
indicating, after identifying, the transitions on the advertisement pod.

19. The computing system of claim 14, wherein applying, using the model, the advertisement pod profile of the plurality of advertisement pod profiles to the advertisement pod comprises overlaying the advertisement pod profile with the advertisement pod.

20. The computing system of claim 19, wherein overlaying the advertisement pod profile with the advertisement pod comprises overlaying the known transitions of the advertisement pod profile with at least a portion of transitions of the advertisement pod.
